(19) United States
(12) Patent Application Publication
(10) Pub. No.: US 2016/0182733 A1
(43) Pub. Date: Jun. 23, 2016

(54) METHOD FOR AUTOMATICALLY RESPONDING TO A CALL

(71) Applicant: Major Langer, Long Beach, CA (US)

(72) Inventors: Major Langer, Long Beach, CA (US); Mourad Benayed, Cupertino, CA (US)

(21) Appl. No.: 14/580,174

(22) Filed: Dec. 22, 2014

(51) Int. Cl. H04M 11/04; H04M 1/60; H04W 4/00; H04M 7/00

(52) U.S. Cl. CPC H04M 11/04; H04M 7/006; H04M 1/6041; H04W 4/008

(57) ABSTRACT

A method for automatically answering a voice-over-IP call comprises inserting an object code in a 3^{rd} party communication application before installing it on a mobile device. The new object code detects incoming voice-over-IP calls, and activates the answering button of the 3^{rd} party communication application. The new object code can also send instructions to a peripheral of the mobile device or to a remote controlled peripheral. The owner can then see a video image of the pet in front of the mobile device and can dispense goodies.

### FIELD OF THE INVENTION

The present invention relates to methods and systems for detecting an incoming voice-over-IP call, and automatically opening the communication lines.

### BACKGROUND

A large number of individuals have mammalian pets in their homes. These are typically dogs or cats. When the pet owners are away at work they often would like to communicate with their pets through their existing mobile devices, and applications on those mobile devices.

Speaker phones have been modified, by the Ablephone company, by adding a large button expander of a “speed dial” button for trained rescue dogs to call 911 in an emergency. While such a system is probably useful for some medical emergencies, it does not provide any “social” communication or emotional comfort on either side.

Unfortunately, such a system to this date there has been no practical means for this sort of communication.

Patent application number 20120255504 titled Domestic Animal Telephone by Kroll et al. discloses a system with a paw switch that enables the speaker phone upon the animal pressing the paw switch.

The current invention does not work with off-the shelf voice-over-IP applications, and requires training the animal on pressing the paw switch.

Thus, there is a need for a system that automatically enables the speaker phone upon calling or upon validating presence of a live animal.

### SUMMARY OF THE INVENTION

A method for updating an application, comprising: combining at least one part of an object code of the application with at least one object code corresponding to a control layer and at least one object code corresponding to a wrapper, wherein the application call answering function requires manual activation and wherein the control layer comprises at least one function that is not provided by the application, and generating a second application; whereby after running said second application, upon detecting an incoming call, the call answering function of the application is automatically activated by the control layer, and the incoming voice stream is directed to an onboard speaker phone.

A method for updating an application, comprising: combining at least one part of an object code of the application with at least one object code corresponding to a control layer and at least one object code corresponding to a wrapper, wherein the application does not verify identity and wherein the control layer comprises at least one function that is not provided by the application, and generating a second application; wherein upon detection of an incoming call, the identity of a user is verified using the control layer, if the identity is authorized, the call answering function of the application is automatically activated by the control layer, and the incoming voice stream is directed to an onboard speaker phone.

A method for updating an application, comprising:
combining at least one part of an object code of the application with at least one object code corresponding to a control layer and at least one object code corresponding to a wrapper, wherein the application does not interface to a peripheral and wherein the control layer comprises at least one function that is not provided by the application, and generating a second application; whereby after running said second application, upon detecting an incoming call, the call answering function of the application is automatically activated by the control layer, upon receipt of a request to activate the peripheral, the peripheral is activated.

### BRIEF DESCRIPTION OF THE FIGURES

The present inventions may be more clearly understood by referring to the following figures and further details of the inventions that follow.

FIG. 1 is a block diagram illustrating wrapping an application

FIG. 2 is a flowchart illustrating the operation of the application wrapper

Similar reference numerals are used in different figures to denote similar components.

### FURTHER DETAILS OF THE INVENTIONS

This invention aims to provide a practical telephone for pets. The major teaching of this invention is a telephone that can be called by a human from a remote location in such a way that the line will be picked up and the animal can attend to the call. Another teaching is an apparatus to allow a human owner at a remote location to release a small food treat to a pet.

Another important teaching of this invention is an apparatus and method to allow audiovisual communication remotely between a pet and an owner. Another important teaching of this invention is a phone with soft fuzzy or soft pliable durable sections for pet licking or chewing.

This patent teaches a method for updating an existing voice-over-IP application (such as Skype) so that the calling party can use it to make a call to a pet. The calling party can activate the speaker phone of a destination mobile device, and can communicate with peripherals of the destination mobile device to dispense goodies.

The current invention injects object code into an existing application. The object code can verify the presence of a pet, activate buttons in the existing application, activate the speaker phone, and issue commands to peripherals. The object code detects incoming communication from the caller and activates one or more processes.

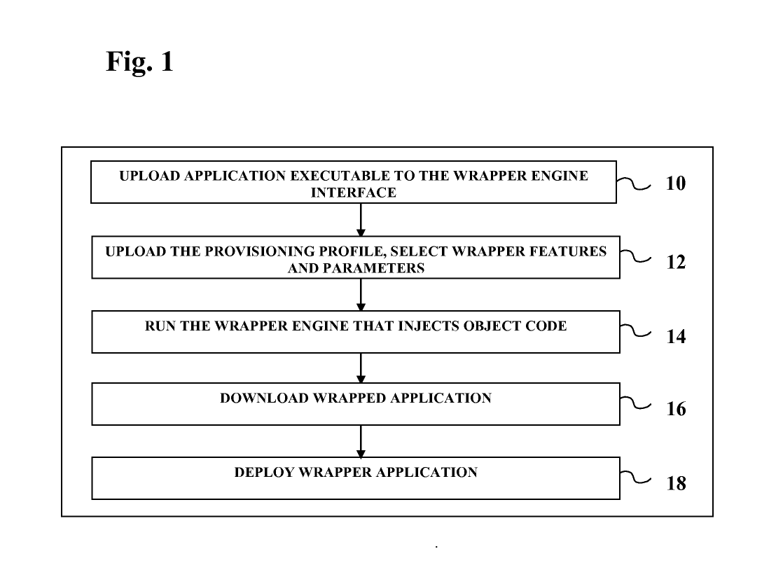

Referring to FIG. 1, the flowchart illustrates the wrapping process. In step 10, the user loads an executable for wrapping. i.e. original application. In step 12, the user sets the wrapper parameters such as: features to include in the application, provisioning profile, wrapper parameters. The wrapping engine may need the private key to sign, and the public key and provisioning certificate to post. The public key may be sent to a certificate authority (CA). In step 14, the wrapper engine injects object in the original application. The injected object code forms the application wrapper. In step 16, the user downloads the wrapped application. In step 18, the user deploys the wrapped application.

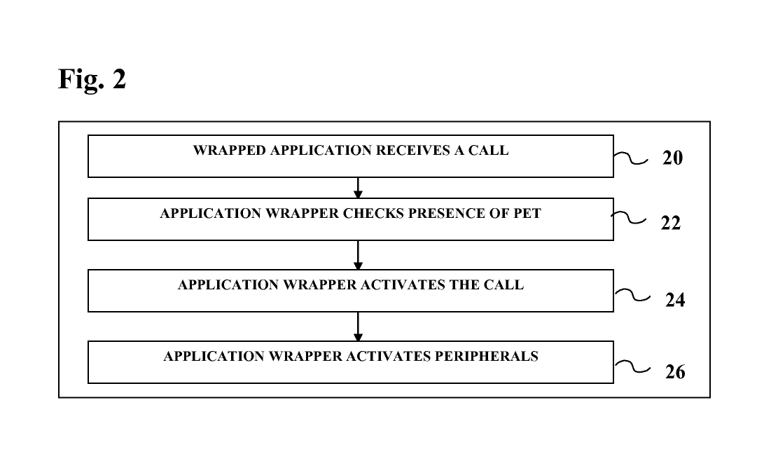

Referring to FIG. 2, the flowchart illustrates operation of the application wrapper.

In step 20, the wrapped application receives a call

In step 22, the application wrapper detects the received call, and triggers new processes. It can check the presence of the pet through video capture and comparison with a reference image, or through sound capture can comparison with a reference recording.

In step 24, the application wrapper activates the call or video call, and the voice is transferred to the speaker phone.

In another embodiment, the application wrapper inserts passwords or codes to the original application.

In step 26, the application wrapper can send commands to peripherals of the mobile device or can send Bluetooth commands to wireless peripherals such as a food dispenser.

It is noted that the wrapper engine will need to sign that application using the new user's certificates, key pair, provisioning profile, etc.

The application can be an application for iOS (for the iPhone), Android (used on handsets from various manufacturers), Windows Mobile 7, Web O/S, Palm, and others.

The current invention consists of inserting a generic security layer into any application without understand the code, and without understanding which modules perform which functions. It combines at least one part of an object code of the application with at least one object code corresponding to a control layer and at least one object code corresponding to a wrapper. For example, if the application call answering function requires manual activation, after wrapping the application and running it, upon detecting an incoming call, the call answering function of the application is automatically activated by the control layer, and the incoming voice stream is directed to an onboard speaker phone.

In another preferred embodiment, the application does not verify identity, however, in the wrapped application, the identity of a user is verified using the control layer and only if the identity is authorized, the call answering function of the application is automatically activated by the control layer.

In another preferred embodiment, the application does not interface to a peripheral, however, in the wrapped application; the call answering function of the application is automatically activated by the control layer.

In another preferred embodiment, the control layer is an actuator and the wrapper is a mechanical wrapper.

The details of certain embodiments of the present inventions have been described, which are provided as illustrative examples so as to enable those of ordinary skill in the art to practice the inventions. The summary, figures, abstract and further details provided are not meant to limit the scope of the present inventions, but to be exemplary. Where certain elements of the present inventions can be partially or fully implemented using known components, only those portions of such known components that are necessary for an understanding of the present invention are described, and detailed descriptions of other portions of such known components are omitted so as to avoid obscuring the invention. Further, the present invention encompasses present and future known equivalents to the components referred to herein.

The inventions are capable of other embodiments and of being practiced and carried out in various ways, and as such, those skilled in the art will appreciate that the conception upon which this disclosure is based may readily be utilized as a basis for the designing of other methods and systems for carrying out the several purposes of the present inventions. Therefore, the claims should be regarded as including all equivalent constructions insofar as they do not depart from the spirit and scope of the present invention. The following claims are a part of the detailed description of the invention and should be treated as being included in this specification.

1. A method for updating an application, comprising:
combining at least one part of an object code of the application with at least one object code corresponding to a control layer and at least one object code corresponding to a wrapper,
wherein the application call answering function requires manual activation and wherein the control layer comprises at least one function that is not provided by the application,
and generating a second application;
whereby after running said second application,
upon detecting an incoming call,
the call answering function of the application is automatically activated by the control layer,
and the incoming voice stream is directed to an onboard speaker phone.

2. The method of claim 1 whereby the control layer inserts a pass code.

3. The method of claim 1 whereby the control layer is an actuator and the wrapper is a mechanical wrapper.

4. A method for updating an application, comprising:
combining at least one part of an object code of the application with at least one object code corresponding to a control layer and at least one object code corresponding to a wrapper,
wherein the application does not verify identity
and wherein the control layer comprises at least one function that is not provided by the application,
and generating a second application;
wherein upon detection of an incoming call,
the identity of a user is verified using the control layer,
if the identity is authorized,
the call answering function of the application is automatically activated by the control layer,
and the incoming voice stream is directed to an onboard speaker phone.

5. A method for updating an application, comprising:
combining at least one part of an object code of the application with at least one object code corresponding to a control layer and at least one object code corresponding to a wrapper,
wherein the application does not interface to a peripheral
and wherein the control layer comprises at least one function that is not provided by the application,
and generating a second application;
whereby after running said second application,
upon detecting an incoming call,
the call answering function of the application is automatically activated by the control layer,
upon receipt of a request to activate the peripheral,
the peripheral is activated.

6. The method of claim 5 whereby the peripheral is a Bluetooth enabled dispenser.
